(19) United States
(12) Patent Application Publication
(10) Pub. No.: US 2009/0307096 A1
(43) Pub. Date: Dec. 10, 2009

(54) METHOD AND SYSTEM FOR ORDER OPTIMIZATION

(75) Inventor: Robert J. Antonellis, Wilmerding, PA (US)

Correspondence Address: WOLF GREENFIELD & SACKS, P.C., 600 ATLANTIC AVENUE, BOSTON, MA, 02210-2206, US

(73) Assignee: Delivery Management Solutions, Inc.,, Medford, MA (US)

(21) Appl. No.: 12/351,773

(22) Filed: Jan. 9, 2009

Related U.S. Application Data
(63) Continuation of application No. 10/821,345, filed on Apr. 9, 2004, now abandoned.
(60) Provisional application No. 60/463,864, filed on Apr. 18, 2003.
(60) Provisional application No. 60/494,263, filed on Aug. 11, 2003.
(60) Provisional application No. 60/501,702, filed on Sep. 10, 2003.

(51) Int. Cl. G06Q 50/00; G06Q 10/00; G06Q 30/00; G08B 13/14; G06K 7/10

(52) U.S. Cl. 705/15; 705/28; 340/572.1; 235/454; 235/462.01

(57) ABSTRACT

An order optimization system and method is disclosed. According to the system and method, a device, such as a personal digital assistant or personal computer is in communication with an establishment computer. The system includes software and hardware capable of placing, transmitting, and receiving an order, tracking the location of the device, determining and predicting the availability of limiting resources, optimally assigning resources to the order, determining whether a triggering condition is satisfied, commanding the preparation of the order, commanding notification messages, tracking limiting resource usage, tracking implements used to prepare the order, and displaying order fulfillment status.

### CROSS-REFERENCE TO RELATED APPLICATIONS

This application claims the benefit of the following U.S. Provisional Patent Applications:
No. 60/463,864, filed Apr. 18, 2003,
No. 60/494,263, filed Aug. 11, 2003, and
No. 60/501,702, filed Sep. 10, 2003,
   each of which is hereby incorporated by reference in its entirety.

### BACKGROUND OF THE INVENTION

1. Field of the Invention

The present invention relates to an order optimization system and method, and more specifically to a system and method that optimizes resource allocation and order fulfillment while increasing service options and efficiency.

2. Description of the Related Art

The throughput of a business is often a function of the availability of a limiting resource. For example, the numbers of different parties that a restaurant can service is a function of the number of tables available as well as how efficiently the tables are used. Generally, the availability of other factors, such as the availability of ingredients to prepare food, can be easily manipulated to serve the restaurant's needs. However, a restaurant cannot easily increase the number of tables that it fits onto its premises. Similarly, the throughput of a pizzeria that delivers pizza is generally limited by the number of available delivery persons and the amount of time expended, on average, per delivery. Of course, different businesses (and even similar businesses with different business models) will often have different limiting resources, and a business may have a number of resources that actually limit its throughput.

Inefficient use and management of limiting resources often leads to less than optimal results for reasons which are not inherently obvious. For example, according to the currently known business models for pizzerias, the manager of a pizza delivery business generally does not know when drivers will return to the shop from making deliveries. The manager's ability to accurately predict when a particular delivery person will return to the shop is a direct result of the absence of a system which tracks the drivers' locations, a system which makes time estimates based on distances between pickup and delivery locations and varying traffic conditions, for example. Thus, the manager does not know when new orders should be prepared for delivery. When orders are prepared too early, they will then sit until a delivery person is available to deliver them (and hence are not optimally fresh when they are delivered). Alternatively, when the orders are not prepared when the delivery person returns to the establishment, the delivery person is idle while he waits for the orders to be prepared. Either scenario is not optimal.

Similarly, when customers go to restaurants, they often need to wait for a table, wait to have their drink order taken, wait to have their entree order taken, wait for the food to be cooked, wait for the food to be served to them, wait for the bill, and wait for their change or credit card receipt. In short, both the customer and the restaurant waste a lot of time waiting. If a restaurant could have the food and table ready when the customer arrives, the restaurant would have a much higher throughput and thus significantly higher revenue because tables would be turned over more quickly.

U.S. Pat. No. 5,648,770, issued to Rose, discloses a system for notifying a party of a pending delivery or pickup of an item. According to Rose, the system compares the location of a mobile vehicle to the location of the party receiving the delivery or pickup. When the vehicle is within a predetermined distance or within a predetermined interval time from the pickup/delivery location, the system sends a communication to the party of the pending delivery or pickup. While the notification system in Rose may be useful, without proper resource optimization, many of the problems discussed above remain.

U.S. Pat. No. 6,026,375, issued to Hall et al., discloses a system that enables service providers to receive an order from a mobile customer, receive customer location information from a location determination system, and schedule the completion of the customer's arrival at a local facility able to satisfy the customer's order. The service provider uses the customer's location to determine a local facility that can satisfy the customer's order. The Hall patent also discloses the use of electronic payments to expedite transactions, and the use of a database of customer transactions that can be used to determine customer preferences. However, in Hall there are no provisions for optimizing resource allocation in the order fulfillment process.

Unfortunately, there remains a need for a system that can optimize resources in the order fulfillment process, while simultaneously increasing service options and efficiency for both customers and service providers. Increased service options and efficiency for customers improves customer satisfaction, which typically translates into increased customer loyalty and increased repeat business. Increased service options typically help a service provider attract a larger customer base; and increased efficiency improves a service provider's throughput, which typically translates into higher profits or improved profit margins.

Thus, it would be more advantageous to provide methods and systems for optimizing resource allocation and order fulfillment while increasing service options and efficiency.

### SUMMARY

In view of the deficiencies described above, it is an object of the present invention to provide methods and systems that optimize resource allocation and order fulfillment while increasing service options and efficiency. It is a further object of the present invention to reduce or eliminate the waiting times in order to save customers time and allow restaurants to serve more meals more efficiently. It is a further object of the present invention to estimate the customer's availability to be serviced by monitoring events which he is attending. It is a further object of the present invention to estimate the customer's availability to be serviced by monitoring the location of a vehicle in which he is traveling.

The present invention is an order optimization system, comprising a device, such as, a personal digital assistant, personal computer, or kiosk, capable of communicating with an establishment computer and transmitting an order to said establishment computer, where the establishment computer has appropriate software and hardware for receiving the order, assigning resources to the order, and commanding the fulfillment of the order. The order optimization system can also include a third party computer, wherein the device communicates with the establishment computer through the third party computer.

The order optimization system can include means for determining and transmitting information regarding the location of said device, such as a global positioning system, a satellite-based radio positioning system, a cellular tower triangulation system, or a system reading the location of an RF ID tag associated with said device.

The order optimization system can also include software and hardware for commanding a notification message, such as a telephone call to a designated telephone number, a telephone page to a designated pager, an e-mail message to a designated e-mail address, an instant message to a designated computer address, a print out, or a message on a visual display. Notification messages can be used to inform customers or establishment personnel of information relevant to the preparation, status, or location of various orders or order components. Preferred notification methods can be stored for specific customers, specific establishment employees or for establishment employees based on job function.

The order optimization system can also include software and hardware for determining when a specific notification message should be sent, such as notifying a customer when a delivery person is about to arrive at a specified location, that a customer's order will be ready in a few minutes, etc.

The order optimization system can include software and hardware for determining the availability of at least one limiting resource necessary to fulfill said order, such as referring to a look-up table comprising information that associates different types of limiting resources with different types of orders, or components thereof. The order optimization system can also include software for optimizing the matching an order to a limiting resource.

The order optimization system can include software and hardware for determining whether or not a triggering condition is satisfied. Triggering conditions can include a customer's arrival at a predetermined location or the time remaining in a sporting event.

The order optimization system can also include software and hardware for limiting the use of a limiting resource, such as tracking limiting resource usage and charging a customer for the use of a limiting resource.

The order optimization system can also include software and hardware for tracking implements used to prepare said order. This can include establishing a unique identifier for each implement, reading the unique identifiers, and associating an implement with said order, as well as evaluating the order fulfillment process or tracking a customer's use of the implements.

The order optimization system can also include software and hardware for displaying an order fulfillment status, displaying available order change options, allowing said customer to change order items that still may be changed without wasting resources.

Other features and advantages of the invention will be apparent from the following detailed description taken in conjunction with the following figures, wherein like reference numerals represent like features.

### BRIEF DESCRIPTION OF THE DRAWINGS

FIG. 1a is a schematic representation of a system according to the present invention in block diagram form.

FIG. 1b is another schematic representation of a system according to the present invention in block diagram form.

FIG. 2a is another schematic representation of a system according to the present invention in block diagram form.

FIG. 2b is another schematic representation of a system according to the present invention in block diagram form.

FIG. 3 shows a method of the present invention in block diagram form.

FIG. 4a shows another method in accordance with the present invention in block diagram form.

FIG. 4b shows another method in accordance with the present invention in block diagram form.

FIG. 5 shows another method in accordance with the present invention in block diagram form.

FIG. 6 shows another method in accordance with the present invention in block diagram form.

FIG. 7 shows another method in accordance with the present invention in block diagram form.

FIG. 8 shows another method in accordance with the present invention in block diagram form.

FIG. 9 shows another method in accordance with the present invention in block diagram form.

FIG. 10 shows another method in accordance with the present invention in block diagram form.

FIG. 11 shows another method in accordance with the present invention in block diagram form.

FIG. 12 shows a nodal network representation of a restaurant delivery business in accordance with the present invention.

FIG. 13 shows a graphical representation of cost/time curves for various service levels in accordance with the present invention.

### DETAILED DESCRIPTION OF THE INVENTION

While this invention is susceptible of embodiments in many different forms, there are shown in the drawings and will herein be described in detail, preferred embodiments of the invention with the understanding that the present disclosure is to be considered as an exemplification of the principles of the invention and is not intended to limit the broad aspect of the invention to the embodiments illustrated.

### Definitions

The term “software agent” or “agent” means a software program that is designed to act on behalf of a party to achieve a goal specified by that party. The party can be a customer, third party, or an establishment. An agent consistent with the present invention has the capability to interact with the user or other humans through some form of user interface, to interact with other agents via some kind of agent communication language, to react to events in the agent environment or in the real world (i.e., user actions) and respond in a timely fashion. An agent may be continuously active or it may be activated for specific periods of time or until it accomplishes a particular goal or function. An agent may communicate with agents both on the same computer as the agent, and on other computers and computer systems.

As used herein, the term “communication” means communication by modalities such as radio frequency (RF), Internet, wireless Ethernet, Bluetooth, modem, cellular phone, or another way obvious to the skilled artisan for two pieces of hardware, software, or agents to communicate with each other. In various embodiments, the term “communication” refers to the inputting of information into a computer terminal by a human being, where the inputted information (either in processed or actual form) becomes available to an agent, software or hardware system. The term “communicate” shall be consistent with the definition of “communication”. Where specific technologies are mentioned, there are mentioned purely by way of example and not by way of limitation.

A “computer” as used herein, shall mean a conventional, commercially available system comprising at least memory and a processor. The memory is a data storage device, such as a hard disk, Random Access Memory, magnetic or optical storage unit, or CD-ROM drive, and stores data, databases or agents used in processing transactions consistent with the present invention. The processor is any commercially available processor with sufficient memory and processing capability to perform the disclosed functionality. In various embodiments, the term “computer” may refer to multiple computers that collaboratively accomplish a desired functionality and are in communication or capable of communicating with each other.

The term “customer” is used herein to mean any entity that orders or procures the good(s) or service(s) of the establishment whether for free or in exchange for compensation. A customer can be a business (or a business' representative), a group of businesses (or their representatives), an individual, or a group of individuals. As used herein, the term “customer” refers to the particular party who is either placing or has placed an order. The customer can be the consumer of the goods or services. In various embodiments, a “customer” is the party that receives or consumes the order but not the party that placed the order. The “customer” can be the party that both places an order and consumes or receives the order.

As used herein, the term “establishment” shall mean any entity that receives orders from customers and, in response to the orders, provides the ordered goods or services. Particularly, the term “establishment” can mean a place of business, and preferably a business that sells, stores, produces, provides, utilizes, sells, stocks, or delivers one or more goods or services, or manages one or more of the foregoing functionalities. In various embodiments, the term “establishment” shall also mean any business or entity that sells, produces, utilizes, stocks or delivers any goods or services that are required by another entity within certain time periods. Establishments may be, by way of example and not limitation, a restaurant, a pizza delivery business, or a pharmacy dispensing prescription drugs.

The term “order” shall mean a request for one or more goods or services.

As used herein, the term “perishable goods” shall mean anything with a limited useful life or a value that changes over time. For example, perishable goods can include food, organs used in transplantation, pharmaceuticals, manufacturing intermediaries for the biotech and food processing industries, chemicals, cheese and wines, and intelligence documents.

The term “service provider” is used herein to mean any entity that receives orders from customers and relays the orders, instructions for fulfilling the orders, or other information related to or based on the orders, to one or more establishments.

The term “activate” as used in relation to an agent, is used herein to mean the creation of a new instance of that agent type, the activation of an existing agent of that type, or simply the communication with an existing agent of that type.

The term “available resource” is used herein to describe a resource which is presently available, scheduled to be available or expected to become available by some defined point in the future.

### Introduction

Consistent with the present invention, an establishment benefits from the methods and systems disclosed herein to increase its throughput of orders and thus to realize increased profit. The methods and systems of the present invention are also useful for ensuring that customers receive the freshest perishable goods and the timeliest services according to their order. The methods and systems disclosed herein may be used by the establishment, by a service provider (or service providers) that provides a service (or services) to the establishment.

Reference will now be made in detail to the preferred embodiments of the invention, examples of which are illustrated in the accompanying figures. Wherever possible, the same reference numbers will be used throughout the drawings to refer to the same or like parts.

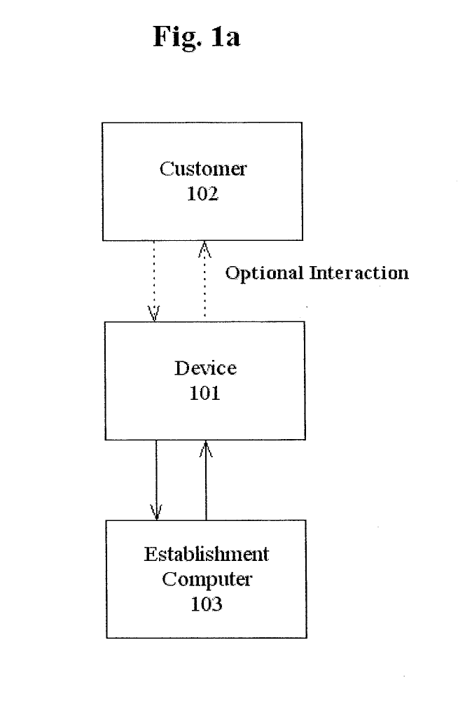

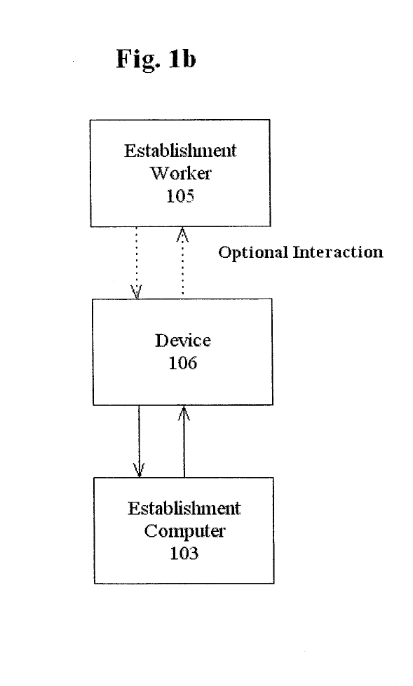

Referring to FIG. 1a, in the simplest embodiment, a Customer 102 (or an agent acting on behalf of the customer 102) places an order through Device 101 and Device 101 communicates the order to Establishment Computer 103.

Referring to FIG. 1b, the Establishment Employee 105 (or an agent acting on behalf of the establishment employee 105) is a delivery person and is sent order fulfillment instructions on Device 106 and Device 106 communicates its location and acknowledgment of receipt of said order fulfillment instructions to the Establishment Computer 103.

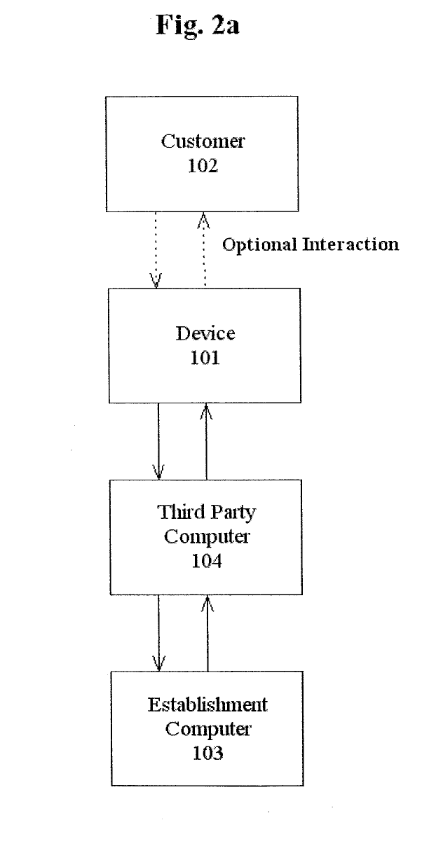

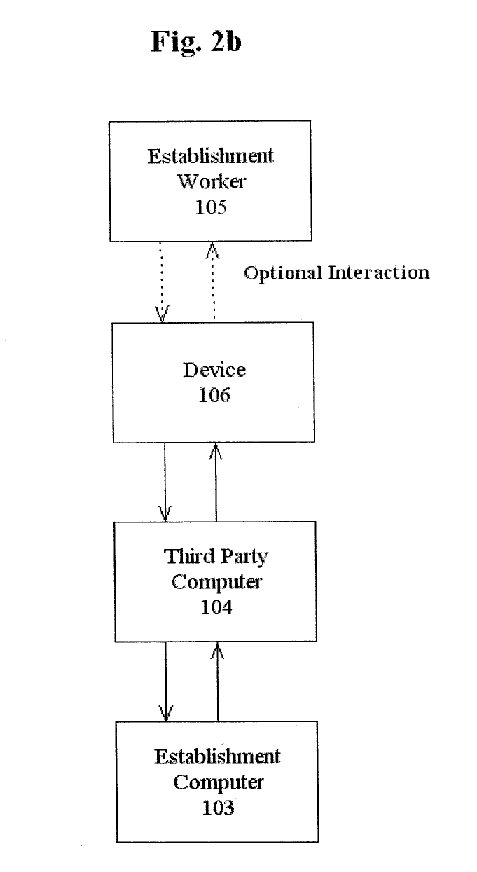

In another embodiment, shown in FIG. 2a, Device 101 communicates with Third Party Computer 104, which communicates with Establishment Computer 103.

In another embodiment, shown in FIG. 2b, Device 106 communicates with Third Party Computer 104, which communicates with Establishment Computer 103.

Device 101 is a device or group of devices through which Customer 102 (or an agent acting therefore) communicates with Establishment Computer 103 or Third Party Computer 104, preferably via a network protocol. Examples of these protocols include wireless Ethernet, cellular telephone, or others known to a skilled artisan. Thus, Device 101 is capable of communicating Customer's 102 order to the Establishment Computer 103 or Third Party Computer 104. Examples include a kiosk, an interactive voice response (IVR) system, an application on a personal digital assistant (PDA) preferably with voice recognition and sound capabilities and a cellular telephone. In other embodiments, Device 101 may be a home or laptop personal computer that is able to connect via the Internet to Establishment Computer 103 or Third Party Computer 104.

In various embodiments, Device 101 is capable of transmitting information regarding its location to an agent that stores this information and makes it available to other agents or software on Establishment Computer 103 or Third Party Computer 104. Thus, Customer 102's location can be ascertained because Customer 102 is presumed to be either carrying or wearing Device 101 or otherwise in close proximity of Device 101. Location information can be collected via the global positioning system, a satellite-based radio positioning system that can provide position, velocity and time information to users equipped with tracking devices and receivers, cellular tower triangulation or other ways known to the skilled artisan. This functionality can also be embodied by having a readable item on Customer 102 or on Device 101, such as an RF ID tag. Positional information could also be transmitted to the Establishment Computer 103 or Third Party Computer 104 by readers in the environment instead of on Customer 102 or Device 101.

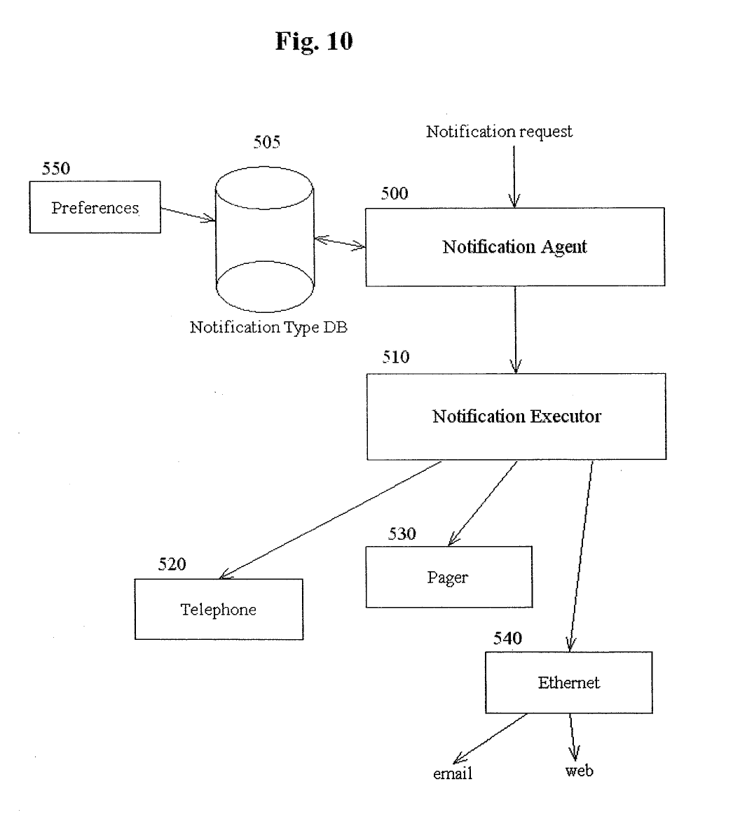

In various embodiments, Device 101 can be used to notify Customer 102. Device 101 is in communication with the Establishment Computer 103 or Third Party Computer 104, and receives notification sent to Customer 102 by Notification Executor 510, shown in FIG. 10 and discussed further below. It can be any device capable of receiving notification from customer Notification Executor 510, such as a cellular telephone 520, a pager 530, an Ethernet device 540, such as a PDA. The skilled artisan will understand that in order to communicate with Customer 102, Notification Executor 510 will need to either receive contact information for Device 101 with the order, or otherwise be able to access this information from, for example, a database that contains this information.

Preferably, Device 101 performs each of these functions, namely (a) allowing the placement of an order with the Establishment Computer 103 or Third Party Computer 104, (b) informing Establishment Computer 103 or Third Party Computer 104 of the location of Customer 102 continuously or periodically, and (c) notifying Customer 102 based on a signal from Establishment Computer 103 or Third Party Computer 104.

Thus, for example, Device 101 may be a single device that allows for one or more of these functionalities (e.g., a PDA). Alternately, Device 101 may be a collection of unrelated devices such as a cell phone (for allowing the placement of an order), a global positioning signal receiver, a transmitter for informing Establishment Computer 103 or Third Party Computer 104 as to the location of Customer 102, and a pager for notifying Customer 102 based on a signal from Establishment Computer 103 or Third Party Computer 104. Thus, Device 101 refers to one or more pieces of hardware that can perform all or some of the functions described above.

Third Party Computer 104 or Establishment Computer 103 may also be in communication with other parties, such as a financial institution (not pictured) that can process payments associated with orders received from Device 101. The skilled artisan will understand that cashless payment is generally faster than cash payment.

Conversely, Device 106 is a device or group of devices through which Establishment Computer 103 or Third Party Computer 104 communicates with Establishment Employee 105 (or an agent acting therefore), preferably via a network protocol, to order fulfillment instructions to Establishment Employee 105. Examples of these protocols include wireless Ethernet, cellular telephone, or others known to those skilled in the art. Thus, Establishment Computer 103 or Third Party Computer 104 is capable of communicating Establishment Employee 105's fulfillment instructions to Device 106. Examples include a cell phone, an interactive voice response (IVR) system and an application on a personal digital assistant (PDA) preferably with voice recognition and sound capabilities. In other embodiments, Device 106 may be a tablet or laptop personal computer that is able to connect to Establishment Computer 103 or Third Party Computer 104 via the Internet or other computer network system.

In various embodiments, Device 106 is capable of transmitting information regarding its location to an agent that stores this information and makes it available to other agents or software on Establishment Computer 103 or Third Party Computer 104. Thus, Establishment Employee 105's location can be ascertained because Establishment Employee 105 is presumed to be either carrying, wearing or otherwise in close proximity to, Device 106. Location information can be collected via the global positioning system, a satellite-based radio positioning system that can provide position, velocity and time information to users equipped with tracking devices and receivers, cellular tower triangulation or other ways known to the skilled artisan. This functionality can also be embodied by having a readable item on Establishment Employee 105 or on Device 106, such as an RF ID tag. Positional information could also be transmitted to the Establishment Computer 103 or Third Party Computer 104 by readers in the environment instead of on Establishment Employee 105 or Device 106.

In various embodiments, Device 106 can be used to notify Establishment Employee 105. Device 106 is in communication with the Establishment Computer 103 or Third Party Computer 104, and receives notification sent to Establishment Employee 105 by Notification Executor 510, shown in FIG. 10 and discussed further below. It can be any device capable of receiving notification from customer Notification Executor 510, such as a cellular telephone 520, a pager 530, an Ethernet device 540, such as a PDA. The skilled artisan will understand that in order to communicate with Establishment Employee 105, Notification Executor 510 will need to be able to access this information from, for example, a database that contains this information.

Preferably, Device 106 performs the functions of informing Establishment Computer 103 or Third Party Computer 104 of the location of Establishment Employee 105 continuously or periodically, and notifying Establishment Employee 105 based on a signal from Establishment Computer 103 or Third Party Computer 104.

Thus, for example, Device 106 may be a single device that allows for one or more of these functionalities (e.g., a PDA). Alternately, Device 106 may be a collection of unrelated devices such as a cell phone, a global positioning signal receiver, a transmitter for informing Establishment Computer 103 or Third Party Computer 104 as to the location of Establishment Employee 105, and a pager for notifying Establishment Employee 105 based on a signal from Establishment Computer 103 or Third Party Computer 104. Thus, Device 106 refers to one or more pieces of hardware that can perform all or some of the functions described above.

Third Party Computer 104 or Establishment Computer 103 may also be in communication with other parties, such as a financial institution (not pictured) that can process payments associated with orders fulfilled via Device 106. The skilled artisan will understand that cashless payment is generally faster than cash payment.

### Resource Optimization

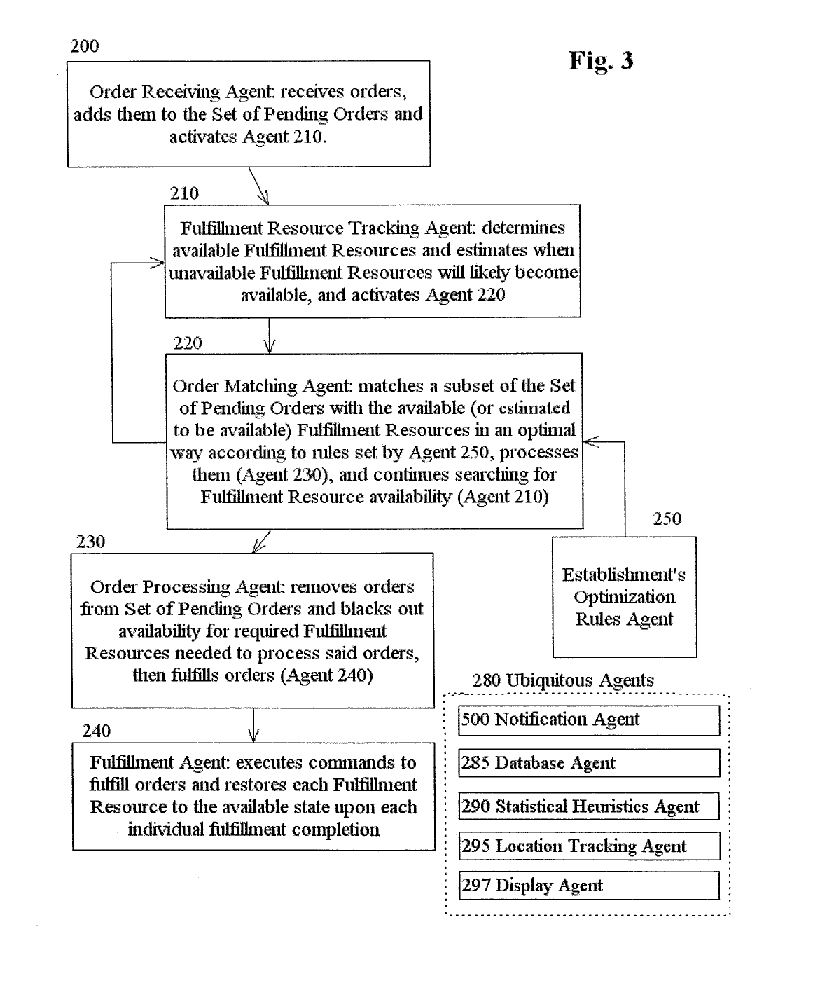

Referring to FIG. 3, Order Receiving Agent 200 receives Customer 102's order (which is preferably placed by Customer 102 according to the method shown in FIG. 1a or 2a). In one embodiment, Customer 102 places an order by cell phone by calling a predesignated phone number that will connect him with Order Receiving Agent 200. Order Receiving Agent 200 may include a telephony system. Customer 102 inputs his order selection through either keypad selections or through audible communication. The telephony system may identify Customer 102 by the number from which he is calling or by his user's inputted Personal Identification Number (PIN) or other unique identifier. In this embodiment, the telephony system includes a memory and program instructions to query its memory for the caller's previous order history or preferences. If the telephony system identifies Customer's 102 preferences or order history, the telephony system can offer him the chance to order his preferred meal, his most recently ordered meal, or another meal associated with Customer 102,. Customer 102 places his order by orally responding to a voice command, by pressing a specific key, by submitting “enter” on a visual interface, or by any other mechanism that would accomplish the same function.

Device 101 may display hierarchical menus that are programmed into Device 101 or served by Order Receiving Agent 200. This system of menus enables Customer 102 to easily select any type, quantity and variety of goods or services offered by the establishment when placing the order.

Alternately, if Customer 102 has a Device 101 with agent capability, it may be an agent that places the order by activating Device 101 or by causing an order to be transmitted to Order Receiving Agent 200. In this embodiment, such an agent serves as the central control point for Device 101 in that all requests, queries, and instructions given to Device 101 by Customer 102 or by other computer systems are initially handled by a Personal agent (not shown). Depending on the type of request or instruction, the Personal agent will perform the appropriate action itself or activate an appropriate software agent to execute the operation. In various embodiments, the Personal agent may be preprogrammed to initiate orders without customer contact. To communicate with Order Receiving Agent 200, the personal agentactivates a Network agent (not pictured), which establishes a connection with Order Receiving Agent 200. Thus, via the Network agent, the Personal agent provides Customer 102 order to Order Receiving Agent 200.

Order Receiving Agent 200 receives the order. In one embodiment, the order is enqueued into a database comprising a Set of Pending Orders. Upon enqueing the order, Order Receiving Agent 200 activates Fulfillment Resource Tracking Agent (“FRTA”) 210. FRTA 210 may be continuously active, and thus Order Receiving Agent 200 may simply communicate with FRTA 210.

FRTA 210 determines the availability of at least one limiting resource that is necessary to fulfill the order. For example, if the order is for food at a restaurant, the limiting resource may be a table for Customer's 102 party. Alternately, if the order is for delivery of food, the limiting resource may be the availability of a delivery person. Among other things, FRTA 210 determines the availability of a delivery driver. If more than one limiting resource may apply to an order, FRTA 210 determines the type of limiting resource(s) necessary to fulfill the order by, for example, referring to a look-up table that associates different types of orders with different types of limiting resources. The skilled artisan will understand that the systems and methods of this invention can be used to schedule fulfillment of any type of order that depends on the availability of a Variety of limiting resources. For example, a restaurant may have excess tables but insufficient wait staff. Under these circumstances, the wait staff may be the limiting resource. In various embodiments, the limiting resource may be table availability for a restaurant, and delivery personnel availability for a delivery business.

In some embodiments, the order may be broken down into multiple components that have different limiting resources. For example, an order for a cappuccino and a pastry may be broken down as follows:

TABLE 1
Components and limiting resources of an order

| Component | Limiting Resource |
|---|---|
| Cappuccino | Availability of cappuccino machine |
| Pastry | None - it is pre-prepared |
| Seating requirement (party of 3) | Availability of a table for 4 to seat the |
| | customer |

Thus, the skilled artisan will understand that the term “component” can refer to a sub-part of the order or to the entire order.

Once FRTA 210 determines the availability (or the scheduled, expected or actual availability) of at least one limiting resource necessary to fulfill an order, it activates Order Matching Agent 220. In some cases, an order can be prepared in part, which may mean that a single resource's availability (or the scheduled, expected or actual availability) can be matched with a single component of the order.

Order Matching Agent 220 matches pending orders, or components thereof, with a limiting resource. For example, in the scenario where the limiting resource is a restaurant table, FRTA 210 may determine that a particular table at a restaurant is expected to become available at a specific time. Order Matching Agent 220 then determines which of a Set of Pending Orders should be associated with the table that is expected to become available. Order Matching Agent 220 performs the function of associating orders (or components thereof) with resources that are predicted to become available based on optimization rules, which may be preprogrammed by the establishment and/or the service provider. Optimization rules may be controlled by the optimization rules agent 250. The systems of the invention may be sold with computer code for allowing the service provider or establishment to modify the optimization rules through a user interface. For example, the simplest optimization rule may be to assign an available resource to the order which was placed earliest in the Set of Pending Orders. More complex optimization rules can take into account factors that are relevant to the needs of customers and/or the particular establishment. For example, in order for a sit-down restaurant to reduce the underutilization of its tables an optimization rule may force the Order Matching Agent 220 to match an available table with a particular customers order because his meal could be prepared more quickly, even though his order was place later than that of another party in various other embodiments, employee utilization and or delivery driver utilization are maximized. Thus, such optimization rules would preferably use these factors, and the customers' needs and preferences that are associated with the order to associate a customer's order with a particular limiting resource. Most preferably, the system of the current invention would comprise memory with program code that would allow the end-user to determine which factors should be used in optimizing the association, and how those factors should be used to match limiting resources with orders.

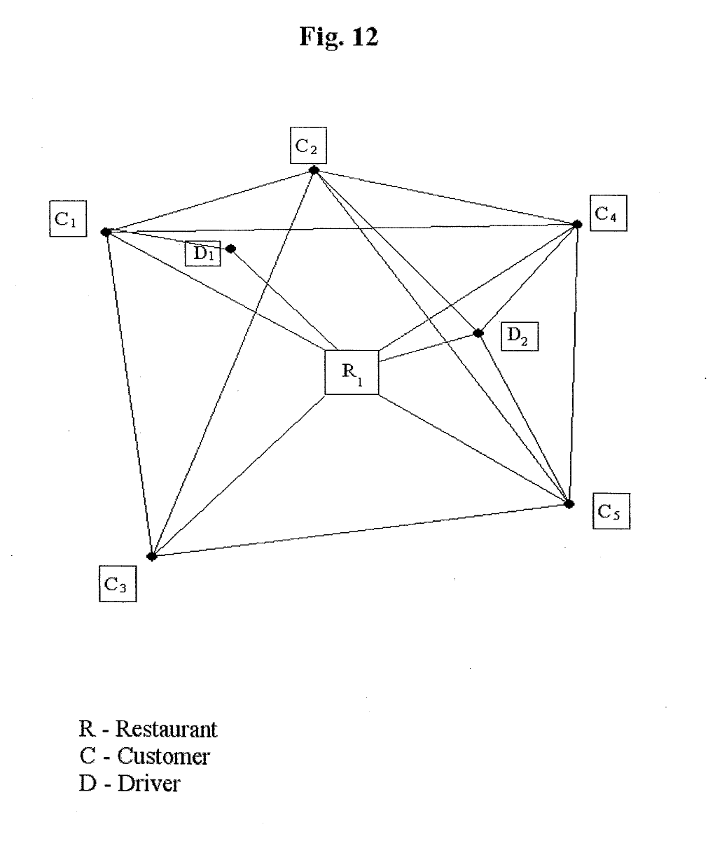

A simplified set of optimization rules, or optimization algorithm, for an establishment with food delivery service can be thought of in the following terms. A delivery point and the establishment are fixed locations. At any given moment, the location of each delivery driver is fixed. If the driver is not at the delivery point, the driver's location can be thought of as the delivery point minus “n” seconds, where “n” is an estimate of the amount of time it will take the driver to reach the delivery point. Each point can be used to form a nodal network, as shown in FIG. 12. Relative spacing between each node can be an estimate of the travel time between each node.

Variables to consider in a simplified optimization algorithm include, but are not limited to: (a) order completion time, “OC”, (b) order set up time, “S”, (c) order transaction time, “T”, and order delivery time. Where order completion time is the amount of time until an order is ready for delivery. Order set up time includes the time it takes for a driver to take the order to the vehicle and prepare to depart. Transaction time is the time it takes the driver to get out of the vehicle, hand the order to customer, receive payment, and return to the vehicle.

As a first example, suppose there are two orders, O1 and O2. O1 will be ready for delivery in 1 minute, OC1=min. O2 will be ready for delivery in 5 minutes, OC2=5 min. A first driver, D1; is at the establishment, ready to go on a delivery, D1=0 min. A second driver, D2, is currently making a delivery and is expected to return in 9 minutes, D2=9 min. Further suppose S=2 minutes for each time a driver goes to make a delivery, and T=3 minutes for each transaction. Using the nodal network shown in FIG. 12, the estimated time from the establishment, E, to customer 1, C1, is 6 minutes, EC1=6 min. The estimated time from the establishment, E, to the second customer, C2, is 5 minutes, EC2=5 min. >From C1 to C2 is 10 minutes, C2C1=10 min. If D1 waits for both orders to be completed and departs to make both deliveries, the time to complete both deliveries is max(D1, OC1, OC2)+S+EC1+T+C2C1. Using the values from the example, the time to complete both orders is 5+2+6+3+10=26 minutes. However, we can also look at a total customer wait time, that is how long did each customer have to wait. Customer 1 waited 13 minutes, max(D1, OC1, OC2)+S+EC1=5+2+6=13. Customer 2 waited the 26 minutes calculated above. Summing these, we get a total customer wait time of 39 minutes.

Alternatively, D1 waits for the first order, O1, to be completed, takes the order and delivers it, and D2 delivers the second order, O2, upon his return. In this alternative O1=max(D1,OC1)+S+EC1=1+2+6=9 minutes, and O2=max(D2, OC2)+S+EC2=9+2+5=16 minutes. Thus, in this alternative each customer has their order within 16 minutes, in contrast to the 26 minutes above, and the total customer wait time is reduced to 25 minutes. Therefore in this example, the optimal solution would be to assign order 1 to driver 1 and assign order 2 to driver 2.

Next, consider an example where both orders, O1 and O2, are ready for delivery, i.e., OC1=OC2=0. As before driver 1 is at the establishment, D1=0, and driver 2 is nine minutes away, D2=9. If driver 1 takes both orders, the time to complete both deliveries is max(D1, OC1, OC2)+S+EC1+T+C2C1=0+2+6+3+10=21 minutes Looking at total customer wait time, customer 1 waited 8 minutes, max(D1, OC1, OC2)+S+EC1=0+2+6=8, and customer 2 waited the 21 minutes calculated above. Summing these we get a total customer wait time of 29 minutes.

However, if driver 1 takes order 1 and driver 2 takes order 2, again we achieve a lower total customer wait time. In this alternative O1=max(D1,OC1)+S+C1=0+2+6=8 minutes, and O2=max(D2, OC2)+S+EC2=9+2+5=16 minutes. Thus, in this alternative each customer has their order within 16 minutes, in contrast to the 21 minutes. above, and the total customer wait time is reduced to 24 minutes. Again the optimal solution would be to assign order 1 to driver 1 and order 2 to driver 2, even though driver 2 is not at the establishment at the time this assignment is made. This result is contrary to what is often practiced in the industry, where driver 1 would have taken both orders.

In the examples sited above, each minute of customer wait time is treated equally, that is, a customer's first minute of wait time is given the same weight was the customer's fifteenth minute of wait time. However, such equal weighting per minute is not an ideal assumption. For example, a delivery order arriving five minutes late would decrease customer satisfaction more than an order arriving five minutes early would increase customer satisfaction. In effect, minutes become more valuable as wait time increases.

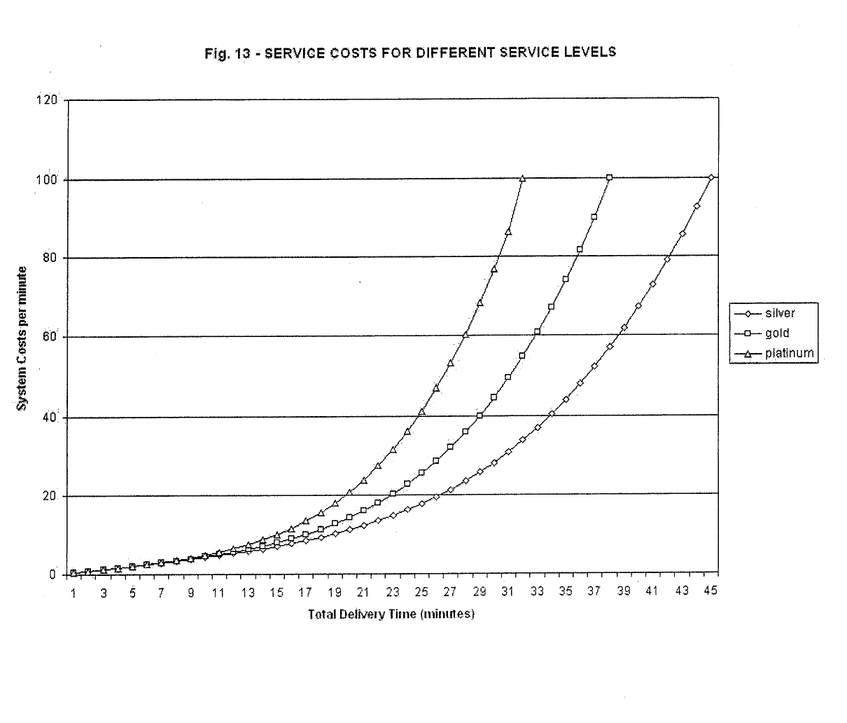

FIG. 13 shows a graphical representation of cost/time curves for various service levels in accordance with the present invention. Multiple service levels can be used to indicate a customer's time being more given more weight than others. For example, a customer who orders frequently may be given “points” for each order. Once the customer has earned enough “points” the customer may achieve a higher service level, e.g., “Platinum Level”, wherein that customer's time is treated as more valuable to the establishment. The optimization rules can take the cost/time curves and multiple service levels into account when assigning resources.

In various embodiments, Order Matching Agent 220 associates components of an order with limiting resources. Thus, for the order described in Table 1, above, cappuccino (i.e., one component of a particular order) may be associated with an available resource: a cappuccino machine. The seating requirement for the order may be associated with yet another available resource: a table with seating adequate for Customer's 102 order.

Once an order is matched with one or more limiting resources, Order Matching Agent 220 activates Order Processing Agent 230, for each of the matching orders. Order Processing Agent 230 removes the order associated with the limiting resource from the Set of Pending Orders, and activates Fulfillment Agent 240. The skilled artisan will understand that the functionality of differentiating the Set of Pending Orders from those associated with a particular resource can be done in different ways. Additionally, the skilled artisan will understand that this functionality may be performed by other agents (e.g., Order Matching Agent 220 or Fulfillment Agent 240). The skilled artisan will also understand that an order containing five items could in theory be processed as five distinct sub-orders; with each of the five sub-orders having attributes which are common with, and expressly unique from, the other four sub-orders.

Fulfillment Agent 240 determines the time when preparation of each good or service in the order selected, should be started. This may be based on the predicted or actual availability of limiting resources necessary to complete the order as well as any preference by Customer 102 to receive or consume the order at a particular time or after a particular point in time.

Generally, goods (or steps necessary for providing a good or service) having a longer preparation time are started earlier than goods or steps having a shorter preparation time. Fulfillment Agent 240 determines the preparation time required for each good or service by referring to a look-up table or by another means that would accomplish the result of allowing Fulfillment Agent 240 to serve this function. Fulfillment Agent 240 determines the steps necessary to complete the order, and causes instructions to be sent for the preparation of the order by activating Notification Agent 500, as shown in FIG. 10. The instructions can be sent at about the time that they need to be executed. In various embodiments, Fulfillment Agent 240 can also command an electrical device, such as a kitchen appliance, to turn on or off at an appropriate time to facilitate order completion.

In various embodiments, the Fulfillment Agent 240 can require a confirmation that an order is completely prepared. While the present invention may track estimated time remaining until an order is completely prepared and thus predict when the order will be completely prepared, having a confirmation that the order is completely prepared can improve order and resource optimization. When an order is completely prepared, an establishment employee can confirm with the system that the order is complete, which will allow the system to optimize the limiting resources used to deliver the order. The establishment employee, such as a delivery driver, can input that a particular order is completely prepared on a device, such as device 106. The system may also send a confirmation request notification to device 106, and the system receives confirmation in response to the confirmation request. Preferably, the system will only accept an order completion confirmation from a device that is known, through device tracking or other means, to be located at the establishment. In the case of a food delivery restaurant, once the system has confirmed that the order is completely prepared, the system can assign the order to a particular delivery driver, which may include reassigning the order from a delivery driver that had previously been assigned the order.

### Resource Optimization Related to Customer's Arrival at the Establishment

In various embodiments, the goods and services are prepared to coincide with Customer's 102 arrival at the establishment. Referring to FIG. 3, Order Receiving Agent 200 receives Customer's 102 order through Device 101. The location of Device 101 (and hence of Customer 102) is tracked continuously or periodically through a location tracking system involving Device 101. In these embodiments, the time when Customer 102 is likely to arrive at the establishment is calculated based in part on Customer's 102 location and direction of travel in relation to the establishment, and in part by an estimate of travel time generated by a computerized mapping program. The commands to prepare the order will be issued so that the order's completion will coincide with the approximate time that Customer 102 is predicted to arrive at the establishment. Customer's 102 arrival time can be calculated based on Customer's 102 distance from the establishment and the speed with which he is traveling towards the establishment. Continuously or periodically, the Location Tracking Agent 295 tracks each inbound customer's location and direction of travel, and estimates the arrival of each customer at the establishment. In various embodiments, the vehicle in or on which customer 102 is traveling is tracked. Vehicle tracking can include, but is not limited to tracking an airplane or automobile in which customer 102 is traveling. Additional refinements can include taking into account the time it takes customer 102 to deplane and travel from an arrival gate to the establishment. This information is available to Order Matching Agent 220, as it attempts to match one or more orders in the Set of Pending Orders with the resources of the establishment. Thus, in these embodiments, the preparation is optimized both to be prepared when the customer arrives at the establishment and also when the limiting resource is available. The skilled artisan will understand that if the order is for a perishable good, it would be preferable to not only prepare the order before the customer arrives, but in some cases to delay preparation so that the order completion can coincide with Customer's 102 arrival. Thus, for example, if absolute freshness is critical, it would be preferable to schedule fulfillment of the order to occur closer to the projected arrival of Customer 102 than if the order is for goods that can be kept fresh through heat lamps, refrigeration or other such devices. The user of the methods or systems of the invention may determine a certain window of time during which different types of orders can sit with little or no loss in value, and use the methods or systems of the invention to have the orders fulfilled within a sufficiently small window of the projected arrival of Customer 102 at the establishment. Also, the entire order may not need to be prepared right before Customer 102 arrives. For example, the freshness of a baked potato may be more easily maintained than that of a sirloin steak, since a heat lamp may tend to cook the meat further than was desired by Customer 102.

The skilled artisan will understand that if the establishment is a sit-down restaurant, the customer's tracked location will preferably be used to also make a table reservation for the customer. A table is an important resource for a sit-down restaurant and should, therefore, be tracked by FRTA 210 and matched by Order Matching Agent 220 with an order in the Set of Pending Orders.

### Resource Optimization Based on Trigger Conditions

In some circumstances, customer may wish to only receive or consume an order after a certain event occurs. For example, if a sit-down restaurant is near a football stadium, a customer may wish to be served a meal after a particular football game is over. Alternately, a customer who has ordered a pizza while away from home may wish his pizza be delivered only after he arrives at his home. When the customer is within a predetermined distance to home, the trigger condition is met, which begins the processing of the order (in some cases, partial order processing may have already occurred prior to the wait for the trigger event to occur) so that it may be delivered to the customer after his arrival at his home. A myriad of other “triggers” could be envisioned by the skilled artisan, including, but not limited to, time remaining in a sporting event, a score in a sporting event, an event in a sporting event (such as a home run or the seventh inning stretch), preparation completion of all the meals for a delivery driver's delivery run, time remaining in a television event, and or time remaining in a live event. Thus, the invention provides systems and methods for fulfilling an order that depends on a trigger event.

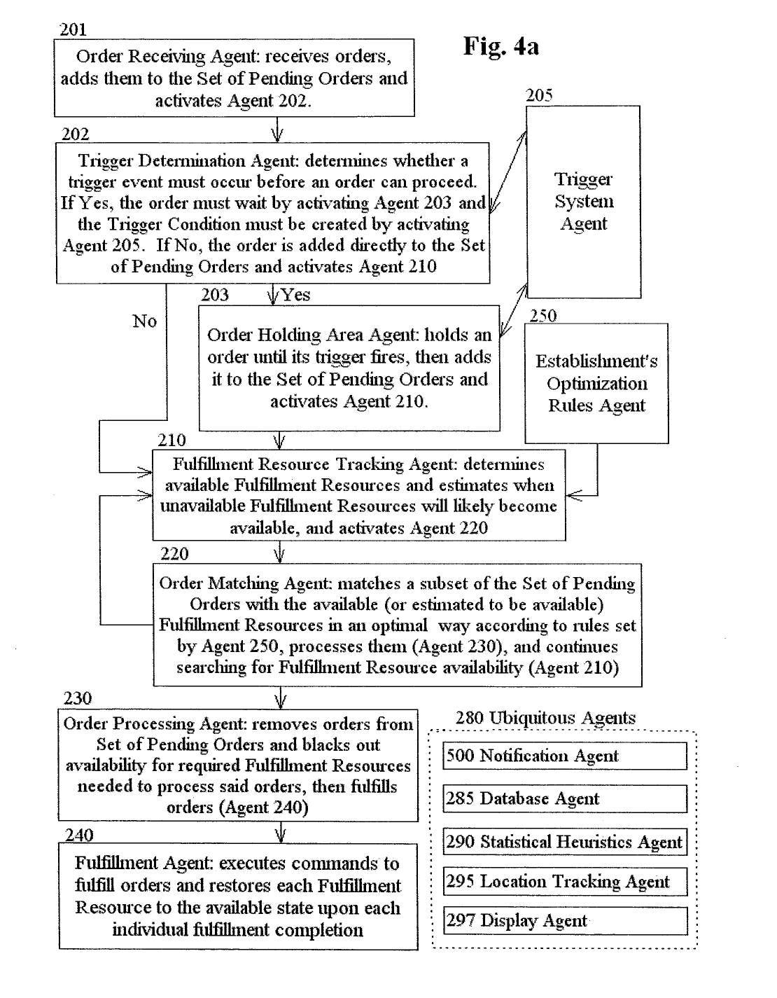

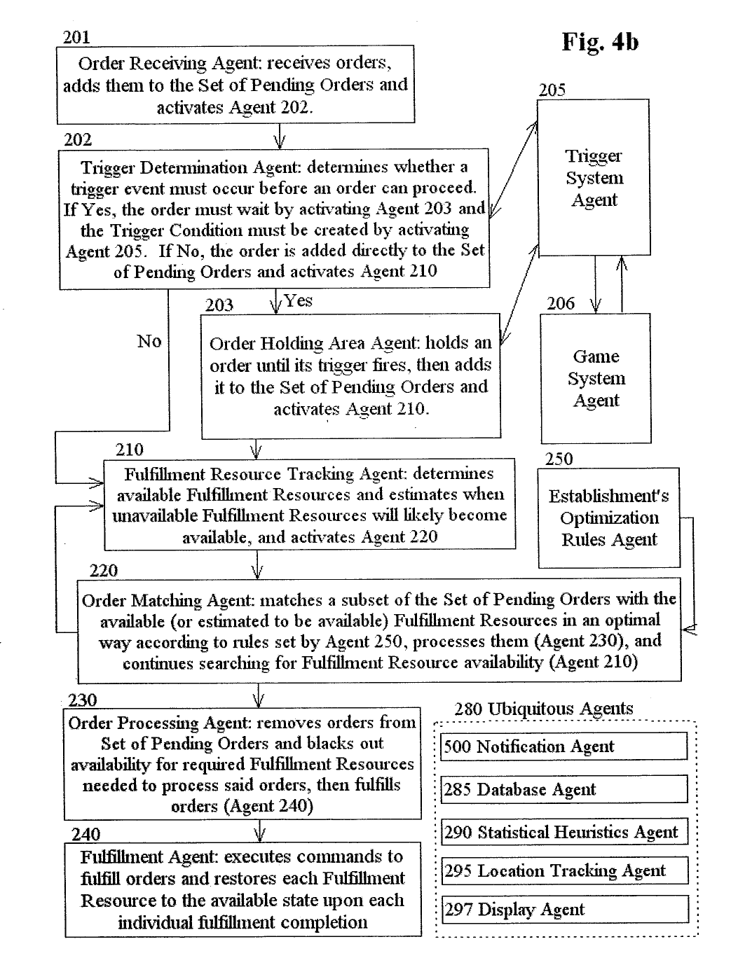

Referring to FIG. 4a, Order Receiving Agent 201 receives an order from Customer 102 as described above, and activates Trigger Determination Agent 202. Trigger Determination Agent 202 determines whether a trigger event must occur before fulfillment of the order can proceed. Such a determination is based on the choices made by Customer 102 when placing the order. It may also be based on the type of order placed by Customer 102 under some business models. If Trigger Determination Agent 202 determines that no trigger event is necessary to fulfill the order, it activates FRTA 210.

If a trigger event is required to fulfill the order, Trigger Determination Agent 202 places the order in Order Holding Area 203, and also queries Trigger System Agent 205 to determine whether a trigger event associated with the particular order has occurred. Trigger System Agent 205 may be in communication with other agents, software or hardware for the purpose of determining whether a trigger event has occurred.

Returning to the example of an order for delivery of a good that is requested to be delivered after Customer 102 returns home from work, Customer 102 may place an order while he is at work requesting certain goods to be delivered to his home after he arrives home. However, Customer 102 may not know exactly when he will arrive at home due to the fact that he'll be picking up his son at baseball practice, and his son's coach sometimes extends practice after they've lost a game. Thus, in this case, the trigger event might be either the arrival of Customer 102 at home, or an event that makes it possible to predict with adequate accuracy when Customer 102 will arrive home—such as Customer 102 coming within a certain pre-determined distance of his home or Customer 102 departing of the baseball field. In addition to the single event triggering the start of the fulfillment of the order, the skilled artisan will construct validation methodologies to increase the likelihood that the establishment will meet or exceed expectations.

In this example, Trigger System Agent 205 is in communication with a Device 101 capable of receiving information about the location of Customer 102, or a Device 101 or vehicle associated with Customer 102. Such a Device 101 may be a global positioning system (GPS) receiver, and such Device 101 should be capable of transmitting its location to Trigger System Agent 205.

In another example, Customer 102 is given the option of ordering a meal to be prepared or delivered at a time relative to a point in a sporting event (e.g., half-time, end of game), shown in FIG. 4b. Trigger System Agent 205 and Game System Agent 206 are used to predict when that point in time will occur. For example, Customer 102 may request that food be delivered at the half-time of a football game, or at the end of a game. Alternately, Customer 102 may request that a sit-down restaurant have the meal prepared and the table reserved and set a certain amount of time after the end of a particular football game. Thus, with the systems and methods of the invention in place, Customers 102 will have the option of ordering goods and services for use or delivery when it would be convenient for Customer 102 in relation to some external event—without knowing ahead of time exactly what time that would be. The skilled artisan will appreciate that the use of a sporting event herein is used only by way of example and not by way of limitation, and countless other events may be used as trigger conditions.

In these embodiments, Trigger System Agent 205 receives a sports feed that provides information about the progress of particular games. Such a sports feed can be procured from SportsTicker.com or similar Internet feeds. Trigger System Agent 205 can predict when a particular event (e.g. start of half time in a football game) will occur by using what is commonly known about things which cause delays in a game of a particular genre and by also understanding how these factors affected game times in the past. Examples of factors which may impact when half-time occurs include: the number of first half time outs remaining for each team, the maximum and minimum length of time for a time out, the historically average length of a time out for that team, at that stadium, the likelihood that a team that's behind will use all of its time outs leading up to the half-time, the weather, and whether any of the players is nursing an injury, among others.

At the start of the game, the estimated beginning of the half-time will be the same as the scheduled beginning of the half-time. But, with each passing minute, there will be a better prediction of the start of the half-time, as the game unfolds, and the number of time-outs reduces (for example) and play resumes. When half-time is imminent, the predictions will be most accurate.

There is always the possibility of unexpected delays, like injuries, which can delay the game considerably. But even time lost to injuries is limited, because an injured player will eventually be removed from the field, so play can resume. So for the most part, the variation would be contained within very controllable periods of time. And as time slips away, and the events of the game unfold, the current time on the clock, the remaining minutes (and seconds) of play, and the remaining number of possible planned delays, along with some factor for the unknown, allows for a statistically sound estimate to be construed for the start of half-time. Thus, using basic knowledge of games like football, as well as historical data and well-known statistical algorithms, the skilled artisan will understand how to develop algorithms that could be used to predict likely times for the occurrence of certain events in sports, such as the likely time of completion of a particular game. This information can be stored and accessed in a game system agent 206.

Once a trigger event has occurred, Trigger System Agent 205 notifies Order Holding Area agent 203, which moves the order to the Set of Pending Orders, and activates FRTA 210.

The skilled artisan will understand that more than one order may be associated with a trigger event. For example, a class of high school students may request that food be ready for them to eat ten minutes after the end of a particular football game. Thus, the same triggering event would be used for each of their orders. Similarly, a bus of tourists may request that their food be ready when they arrive at the establishment. In this situation, the location of the bus may be used as a trigger to determine when each of the tourists' meals needs to begin to be prepared.

Additionally, as described above, an establishment or service provider may wish to have a look-up table showing the preparation time for the goods or services that it sells. The look-up table preferably breaks into multiple steps the different goods or services is sells. For example, the steps to make a pizza are (a) flattening the dough, (b) adding the sauce and toppings, and (c) cooking the pizza in the oven for certain amount of time. The skilled artisan will understand that after steps (a) and (b), the pizza does not necessarily need to go immediately into the oven. In fact, the skilled artisan will realize that the uncooked pizza could be placed on a rack, and thereby be maximally prepared for a trigger event to occur, at which point the pizza will then be inserted into the oven for cooking (step c).

Once FRTA 210 is activated, the remainder of the steps in the process are similar to what is described in FIG. 3.

Shown in FIGS. 3, 4a, and 4b, is a group of ubiquitous agents 280. These agents may be accessed and utilized throughout the process of the present invention. Notification agent 500 is discussed in detail below. Database agent 285 is used to access historical data for customer 102 or other order data. Statistical heuristics agent 290 is used to record system performance and report statistical data regarding resource usage and optimization. Location tracking agent 295 is used to track the location, using any of the methods described above, of a customer, a delivery person, or an order preparation implement.

Ubiquitous agents 280 may also include Display agent 297. Display agent 297 may be used to display information, graphically, or otherwise, regarding order status, delivery status, customer locations, delivery driver locations, or other information as may be needed or desired, on a computer monitor or other device. In various embodiments, Display agent 297 may be accessed via a computer network, such as the Internet, wherein a customer may receive information regarding their order or orders.

### Notification Agent

The skilled artisan will understand that notification is an important aspect of a number of systems and methods of the present invention. For example, referring to FIG. 3, Fulfillment Agent 240 causes fulfillment of the order by communicating instructions to the staff of the establishment to perform tasks necessary for the completion of an order. Similarly, if the establishment delivers orders to customers, it would be useful to notify the delivery person when an order is assigned to him, discussed in detail below.

Thus, referring to FIG. 10, Notification Agent 500 receives a notification request. The notification request can be sent by any agent or software program. In some embodiments, a human being may input a notification request into a computer terminal, a PDA, a cell phone or other such device that is in communication (or capable of communication) with Notification Agent 500.

Preferably, Notification Agent 500 is in communication with Notification Database 505. Notification Database 505 contains preferences as to how individuals wish to be contacted. For example, Notification Database 505 may contain an establishment staff member's pager number, a particular customer's IM address, and so forth. Establishment staff members may be able to input their notification preferences into a computer terminal. Alternately, the establishment or service provider may require that staff members be notified in a specified manner (e.g., through establishment-issued pagers) and thus cause the inputting of sufficient information to effectuate this into Notification Database 505. The skilled artisan will understand that different establishment employees may be notified differently. For example, if the establishment is a restaurant, chefs may be notified via a printer on an establishment internal network. On the other hand, the maitre d′ may be notified via a display at the maitre d′ station that can display information it receives via a wireless Ethernet network, through an e-mail that can be displayed at the maitre d′ station, or by some other way.

In some cases, Customer 102 may have the option, when placing an order through Device 101 or some other means, of specifying how Customer 102 wishes to be notified. For example, the establishment may offer a delivery service, and Customer 102 will have the option of receiving notification a pre-determined amount of time before the delivery is made.

If the Notification Database 505 does not specify a particular way to notify a particular person, it may list rules for particular sets of people. For example, the establishment may have a preference that all establishment staff should be notified via the establishment's e-mail system. Thus, though the Notification Database 505 may not list a particular notification method for a particular cook, that cook may be classified as an establishment cook, and thus Notification Agent 500 will know that according to the establishment's preferences, the particular cook needs to be notified a certain way.

Thus, when Notification Agent 500 receives a notification request, it queries Notification Database 505 to determine how the notification should be sent. It then activates Notification Executor 510. Notification Executor 510 then causes notification to be sent to the notification recipient through any of a number of diverse notification systems. For example, Notification Executor 510 may cause the notification recipient's telephone to ring and for an automated message to be played once the recipient's telephone is answered, the recipient's pager to be sent a message, sounding and alarm on the recipient's PDA, causing a vibration on recipient's PDA, or through any other way sufficient to allow the recipient to be notified.

The skilled artisan will understand that in some embodiments, Notification Executor 510 will cause notification to be sent as soon as it is activated by Notification Agent 500.

In other embodiments, the notification request received by Notification Agent 500 will state that the notification be sent only at, before or after a particular time. Thus, Notification Agent 500 will determine whether the notification request requires that the notification be sent at or after a particular time, and will only activate Notification Executor 510 at a time so that Notification Executor 510 causes the notification to be sent out in conformance with the time parameters in the notification request.

The Notification Database 505 contains not only the preferred means of notification, but also could contain other preferences which include the amount of advance notice required for a particular type of notification. A particular customer, for example, who decided to wander through a shopping mall to fill the time until he's notified that his table is set and his meal is ready, may wish to be notified a fixed number of minutes before he should return to the establishment. Conversely, he may be provided with the choice of preferences which include the tracking of his location in the mall (his location could be tracked through the tracking of Device 101's location), so that his advance notification could be based on the expected time for him to walk to the establishment, based on the preferred walking speed he entered as a preference.

### Limiting Usage of a Limiting Resource

A limiting resource generally limits an establishment's throughput. Thus, for example, if the establishment is a restaurant, and the limiting resource is a table, the number of customers that the establishment will be able to serve (and thus the amount it can earn) will be positively correlated with the speed with which tables are turned over. Thus, the invention provides methods and systems for motivating customers to quickly use the limiting resource.

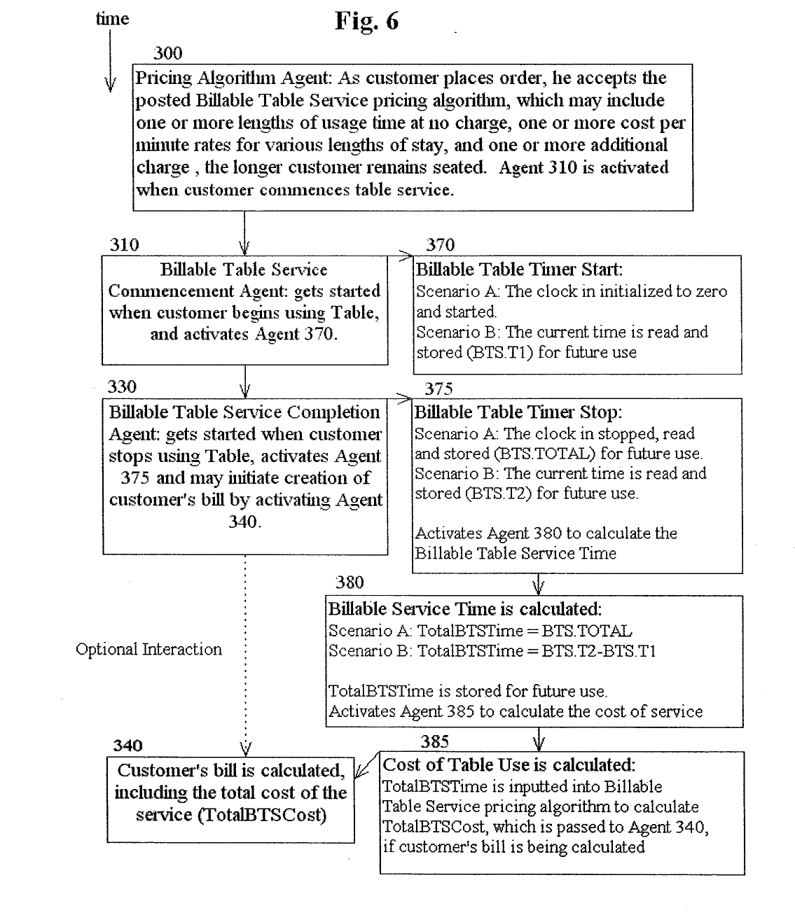

Referring to FIG. 6, a Customer 102 is preferably informed that he will be charged for the use of a particular limiting resource, as defined by Pricing Algorithm Agent 300, before or while Customer 102 places the order.

When Customer 102 begins using the resource, some electronic communication activates Billable Table Service Commencement Agent 310, which then starts the Billable Table Timer Start Agent 370.

The time when Customer 102 starts using a particular limiting resource can be determined in any of a number of ways. For example, a member of the establishment staff (e.g., the maitre d′) may press a button that closes a circuit thus causing the sending of a signal to Establishment Computer 103—thus notifying Establishment Computer 103 that a particular resource is now in use. This button may be pressed as soon as Customer 102 is seated at a particular table. Alternately, sensors may be near (or under) the table and thus when they start registering the presence of a human being, a signal could be communicated to Agent 310 indicating that the particular resource associated with the sensor is in use. Alternately, Customer 102 may wave a smart card over a transponder, thus notifying Agent 310 that Customer 102 has arrived at the establishment. In yet another embodiment, a maitre d′ or another establishment staff member could manually input into Establishment Computer 103 the time when Customer 102 begins use of a particular resource.

Similarly, the time when Customer 102 stops using a particular limiting resource can be determined in any of a number of ways. But it's possible that Customer's 102 departure from the table would be recorded with the same means as was used to mark the beginning of his stay at the table. His departure activates Agent 330, which then activates Agent 375. Agent 330 may be activated by manual entry into Establishment Computer 103 when Customer 102 stops using the limiting resource, by receiving the customer's authorization to pay for the order received at the establishment, by the pressing of a button located on or near the limiting resource that completes a circuit that activates Agent 330, by sensors on or near the limiting resource which no longer register Customer's 102 presence, or by some other way that can achieve the same result.

Alternately, as shown in FIG. 6, Agent 310 may initialize a timer at zero by activating Billable Table Timer Start Agent 370: Scenario A and Agent 330 by activating Billable Table Timer Stop Agent 375: Scenario A stops the timer that was initialized and that is associated with the resource used by Customer 102 when it receives communication that Customer 102 is no longer using the limiting resource. Billable service time is calculated at 380 and the cost of the use of the limiting resource is calculated at 385.

Agent 340 prepares Customer's 102 bill according to methods commonly known to the skilled artisan (e.g., by preparing a list of goods ordered and calculating the total amount due including tax, etc.). Agent 340 calculates the amount due for the use of the resource for inclusion on the bill. Agent 340 generates a bill for Customer 102 which preferably includes charges for the goods or services ordered by Customer 102.

In some embodiments, the establishment may only charge Customer 102 for use of the limiting resource above a certain amount of time. For example, the first thirty minutes at the table may be free. In this case, Agent 340 calculates the amount of time that the customer used the table above the thirty minutes to determine Customer's 102 bill.

In some embodiments, the customer can see how long he has been using the table in real time, on a display. The display can be any conventional display such as a CRT or LCD display, or even be part of Device 101.

Thus, for example, an establishment may charge Customer 102 $0.50 for every minute that Customer 102 uses a table after the first thirty minutes. For the first thirty minutes, the display may say “No Charge”. Preferably, it would also show the amount of time remaining until the customer starts to be charged for the use of the limiting resource. After 31 minutes, the display would indicate that Customer 102 will be charged a total of fifty cents, after 32 minutes, one dollar, and so forth.

For example, Agent 310 may initialize a clock at zero by activating a Billable Table Timer Start Agent 370 that is visible to the customer when the customer begins to use the limiting resource. In another embodiment, Agent 330 may initiate a display that is visible to the customer that shows how much he will be charged for using the limiting resource as he is using it.

### Uniquely Identifiable Kitchenware

In various establishments, it would be useful to track the location of implements used to prepare the order in order to facilitate an automated computerized service tracking system. This would provide the establishment with real time opportunities to enhance customer service, provide periodic reports to management about actual service times, and build a foundation for further improvements, while requiring virtually no labor to implement.

For example, if the establishment is a restaurant, each piece of kitchenware may have a bar code, RF tag or other good that can be used to uniquely identify the kitchenware. As used herein, the term “kitchenware” refers to plates, utensils, serving dishes, and other such items. The skilled artisan will understand that readers need to be available to read the unique identifier (e.g., a bar code reader or an RF tag reader). The readers may be available at each cooking station, may be carried or worn by one or more members of the establishment staff, or may otherwise be available in the environment.

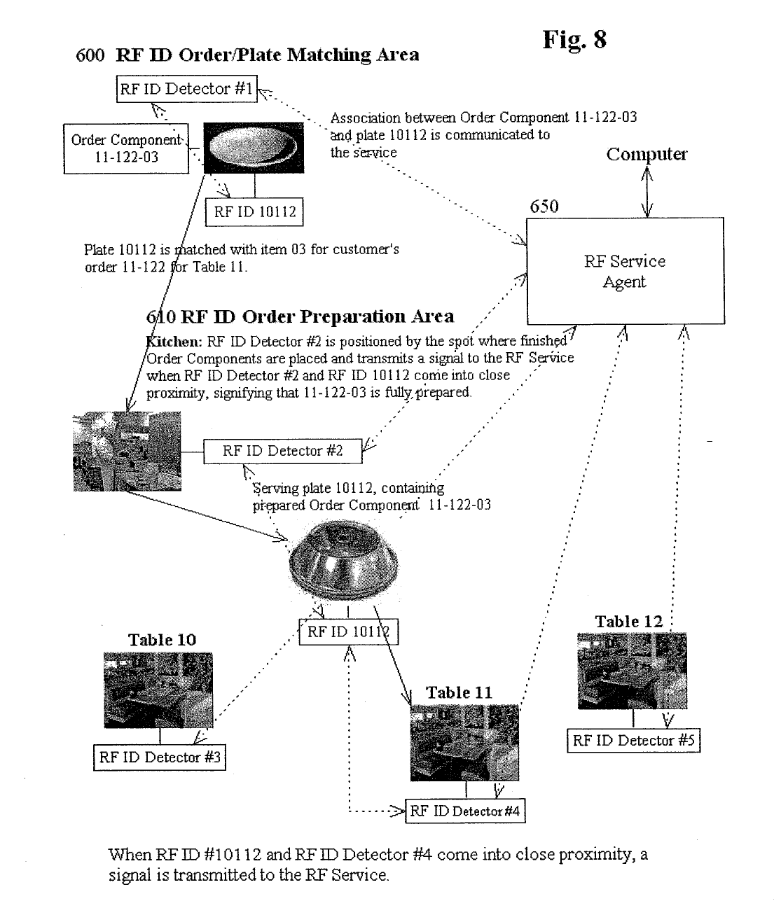

In one embodiment, shown in FIG. 8, each kitchenware piece has an embedded RF tag. Thus, in RF ID Order/Plate Matching Area 600, a piece of kitchenware (which is embedded with RF ID 10112) is associated with a particular good ordered by a particular customer (e.g., good 11-122-03) at the RF ID Order/Plate Matching Area 600. RF ID Detector #1 reads the RF tag, and transmits the identifier it reads to RF ID Service Agent 650. At roughly the same time that the RF tag is scanned, a staff member of the establishment chooses an item on an order to associate with the kitchenware by, for example, selecting it from a graphical menu. Or, the item may already be chosen for him and he simply follows the instructions to scan the plate and put a 12 oz. sirloin strip, cooked medium well, onto the plate.

Alternately, when items are prepared ahead of time, a slightly different method can be used since there may be no order with which to associate the item, at the point when the utensil is being associated with the food. For example, salads may be prepared before the restaurant opens, and therefore, before any orders have been received. So, the RF ID tag embedded in a plate needs to be associated with a particular type of salad sold by the restaurant, in the Order/Plate Matching Area 600. The plate will be scanned with RF ID Detector #1, but matched with a non-customer specific part number using the same graphical menu. The item could be for a “Garden Salad”, and the RF ID Service will record the association between the specific plate (or specific salad bowl) and the particular type of salad sold by the restaurant, and update the computer's inventory of Garden Salads. But only later, when there's an actual customer order for a Garden Salad, will there be the need to associate a specific Garden Salad with a particular embedded RF ID tag with that order. And this association could be created by the waitress, as she scans the plate containing the Garden Salad by the RF ID Detector in the Salad Final Prep Area (not shown in FIG. 8) or the plate could simply be associated with the customer's order when it's in close proximity of RF ID Detector #4, at Table 11, for example. There are certain benefits to making this association at the table: that the waitress won't overlook the step of giving the customer the salad nearly as easily as she might overlook the step of scanning the salad at the Salad Final Prep Area.

RF Service Agent 650 may access a database that associates different RF identifiers with the type of plate or utensil on which the associated RF ID tag is embedded. RF Service Agent 650 may also access a second database that associates different goods and services sold by the establishment with the different types of kitchenware necessary to prepare or serve the particular good or service. Preferably, RF Service Agent 650 stores information about the association between particular pieces of kitchenware and particular orders or components thereof.

As each piece of kitchenware moves through the preparation of the order in the establishment, its progress can be tracked. For example, let's assume that the order is for sirloin strip and coffee, and that the sirloin strip component of the order is associated with a plate having a unique identifier 17453 (not shown). Using detectors, the progress of plate 17453 can be tracked through the kitchen, and therefore the sirloin strip component can be tracked through the kitchen. For example, a detector near the grill can read when plate 17453 came into its range and when it left. Thus, the skilled artisan will be able to design the kitchen of the establishment (or any other area of an establishment) with appropriately placed RF ID detectors, so that the desired steps in the flow of orders through the establishment can be accurately measured.

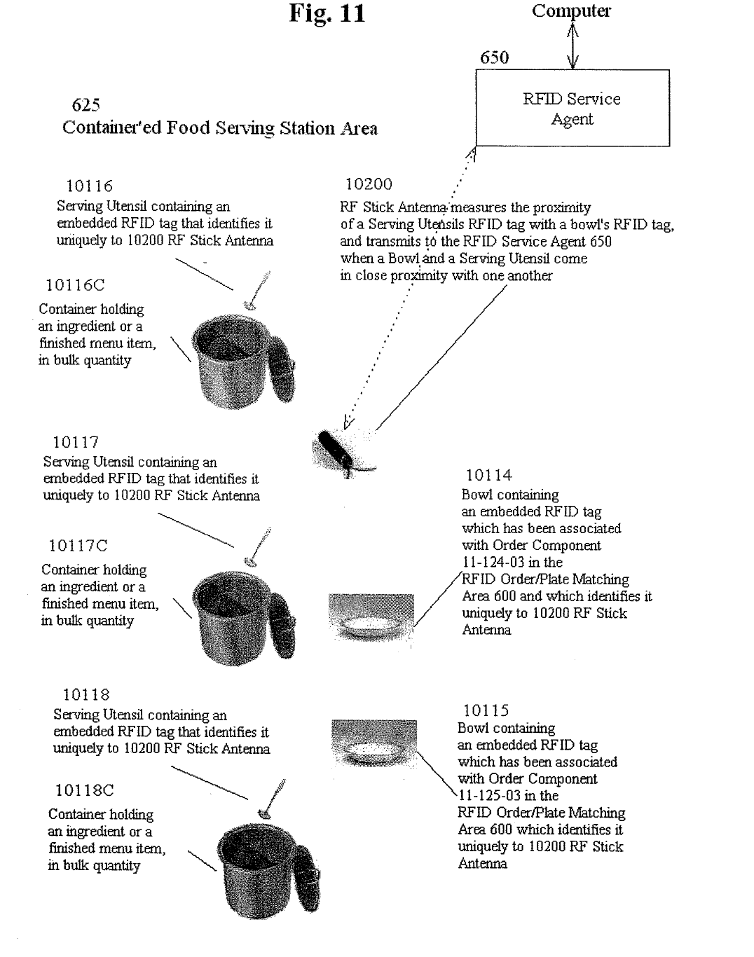

FIG. 11 shows uniquely identifiable implements used during food preparation. At a containered food serving station area 625, RF ID tags are used to track ingredients and order fulfillment by tracking service items associated with an order and their proximity to containers. RF Service Agent 650 tracks the orders.

Many establishments have a place where completed orders are stored until they are delivered to the customer. For example, a restaurant may have a heat lamp under which food is stored until a staff person is available to take the food order to the customer. Thus, an RF Detector #2 reads RF ID tags on kitchenware in the area where completed goods are placed, such as a heat lamp, and communicates that it has read the ID tags to RF Service Agent 650. Finally, when the order is given to the customer who ordered the order, such as at a table in an establishment where customers eat, RF ID Detector #11 (which is positioned within sufficient proximity to read the RF tags on kitchenware on Table 11) reads the RF ID tags of the plates and utensils on the table, and communicates the tags that it has read to RF Service Agent 650.

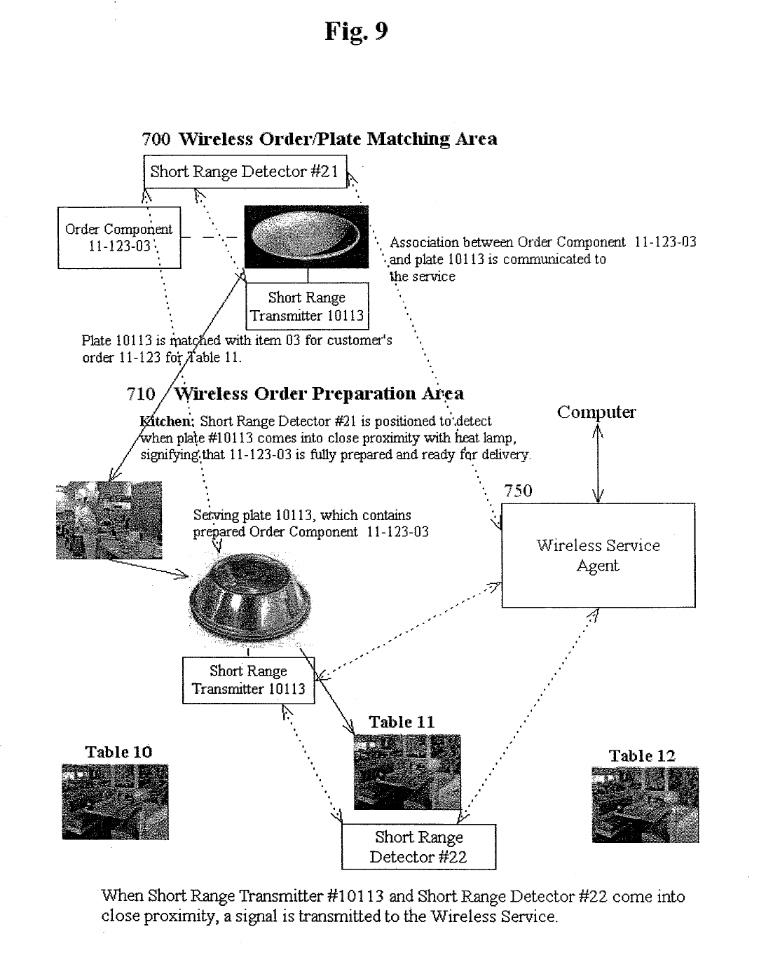

In another embodiment, shown in FIG. 9, short range transmitters and short range detectors are used to follow the progress of kitchenware through the preparation and service process. Wireless Service Agent 750 matches order components and implements at the wireless Order/Plate Matching Area 700. Detectors are used to detect when an order is ready for delivery in the Wireless Order Preparation Area 710.

The skilled artisan will understand that there are other ways to label kitchenware with unique identifiers and to read those identifiers. Furthermore, the examples given herein are given by way of example and not by way of limitation.

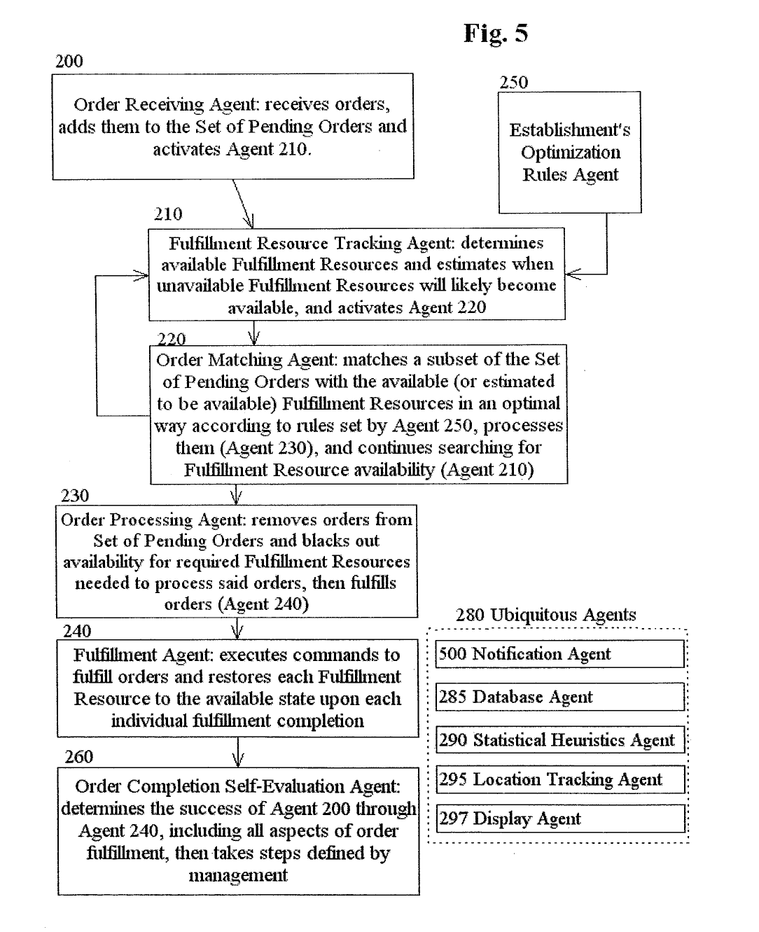

Thus, referring to FIG. 5, Order Completion Self-Evaluation Agent 260 can evaluate how long it takes for kitchenware with a particular order to go from station to station, and thus presumably for steps associated with preparation that takes place at each station, to be completed. The establishment may have predetermined time standards for each step of the preparation process of components of the order. The establishment can then compare its standards against the actual time that it takes to complete an order. Such comparison will give the establishment information about whether the standards are being met and, if not, in which parts of the process they are not. Such information can then be used to improve the establishment's procedures.

An RF ID tag could be affixed to the kitchenware utensil by a host of means, including embedding it into the utensil and taping it to the utensil with heat curing tape. Ideally, the RF ID tags are made from silicon or similar materials, which can withstand high temperatures, so the temperature reached by the dry cycle of an automatic dishwasher or a bake oven should not damage the tag.

FIG. 9 shows a Wireless Ethernet variant of the invention. This technology would enable an establishment to track customer service where it matters most: the time that it takes for the plate to reach the table. But it can facilitate the tracking of the customer's meal throughout the establishment by helping the management to pinpoint the delays and bottlenecks which make the customer wait. And there are a host of notification and reporting capabilities which are made possible by way of this tracking.

By having the ability to track any serving portion of food or beverage by some means, a cafeteria could conceivably reduce the number of cashiers it needs to process a fixed amount of customers. The plates could be associated with specific food items on the cafeteria's menu, which could facilitate customer self-checkout.

For things like a dessert bar, each plate could be associated with a food item when the dessert bar is being stocked. Then, at a later time, a customer can take a piece of chocolate cake from the display case, for example, and bring it to his table to eat it. If the table is properly outfitted with a detector, and if the customer has properly associated himself (and therefore some form of electronic payment capability) with the table, he simply needs to retrieve the cake, sit down and eat it. He need not wait in line and he need not remove his wallet from his pocket. This new level of cafeteria service could increase the number of customers who are willing to go back for dessert, for example.

In an alternate cafeteria venue, when entrees are transferred from a heated tray to an individual plate by an employee of the establishment, the employee must associate the plate with the food item which he's placing onto the plate. This can be performed by selecting it from a graphical menu, or an entire stack of dishes could be already designated to be used with the “Entree of the Day”.

### Tracking Whether Customer's Done Eating

The RF ID tag and the Wireless Ethernet solutions described above could do more than simply communicate the kitchenware utensil's location to a service. They could also track whether Customer 102 has finished eating from his plate, by using an RF ID tag which was designed to be consistent with this invention, for example.

While a person eats from the plate (or bowl), his eating utensil is hitting the ceramic, and producing vibration and sound within a given frequency range. And since there are numerous devices currently sold which measure sound and vibration with a high degree of precision, the skilled artisan could purchase or build a device which tracks the occurrence of vibrations within a certain frequency range. When the vibration (within a certain frequency range) occurs, it could set an internal clock to zero and start the clock running. Then each period (a period could be 10 seconds), it could check to see how high the clock has gotten. When the clock has reached 5 minutes, for example, the device could communicate to the RF ID Service that Customer 102 has stopped eating from plate #23145.

This is useful information since it could become the basis for additional notifications, to provide enhanced customer service. Let's say that a steak is served to a customer, and that within the first minute of having been served the steak, the customer has stopped eating. This might be the right time for the waitress (or the manager) to be notified, so that either of them could ask the customer if the steak is cooked all right. When a steak is over cooked (or under cooked) it's usually visible to the customer right away. And when the customer isn't happy with his steak, he won't typically eat any more of it.

Another use for this invention is that of data collection. It allows the restaurant to collect data on the length of time it takes customers typically to eat the various meals served by the restaurant. This data will accumulate at no additional cost to the restaurant, but when they view large amounts of data, there may be some surprises there. For example, they may discover that a sirloin strip steak takes longer to eat than prime rib, and they may attribute this to the tenderness of the meat. They may then conclude that it helps their turnover rate when people eat prime rib, which may entice them to lower the price of prime rib. Or they may discover that customers who's entrees are consumed in less than 10 minutes are twice as likely to order dessert.

Changes and Cancellation of Orders without Wastage

As described above, the invention comprises improved methods for tracking the progression of kitchenware, such as plates and utensils, and also including oven timers or the time an item is on a stove or grill, associated with an order, or a component thereof, through different stations of the establishment. Thus, based on the time that kitchenware associated with an order or order component was scanned by a detector at a particular station used in the preparation of the order, one can determine whether an aspect of the order can still be changed or canceled without resulting in a waste of materials and a potential charge to the customer. For example, let's assume that the order is for a well-done sirloin strip. When the raw sirloin strip is brought to the grill, the unique identifier of the kitchenware in which the raw sirloin strip is transported may be scanned by a scanner associated with the grill. Alternately, right before the sirloin strip is put on the grill, a bar code having a unique identifier associated with the sirloin strip may be scanned by a detector. Regardless of the particular methodology, a computer in communication with the detector will receive information allowing it to determine approximately when the sirloin strip has been put on the grill.

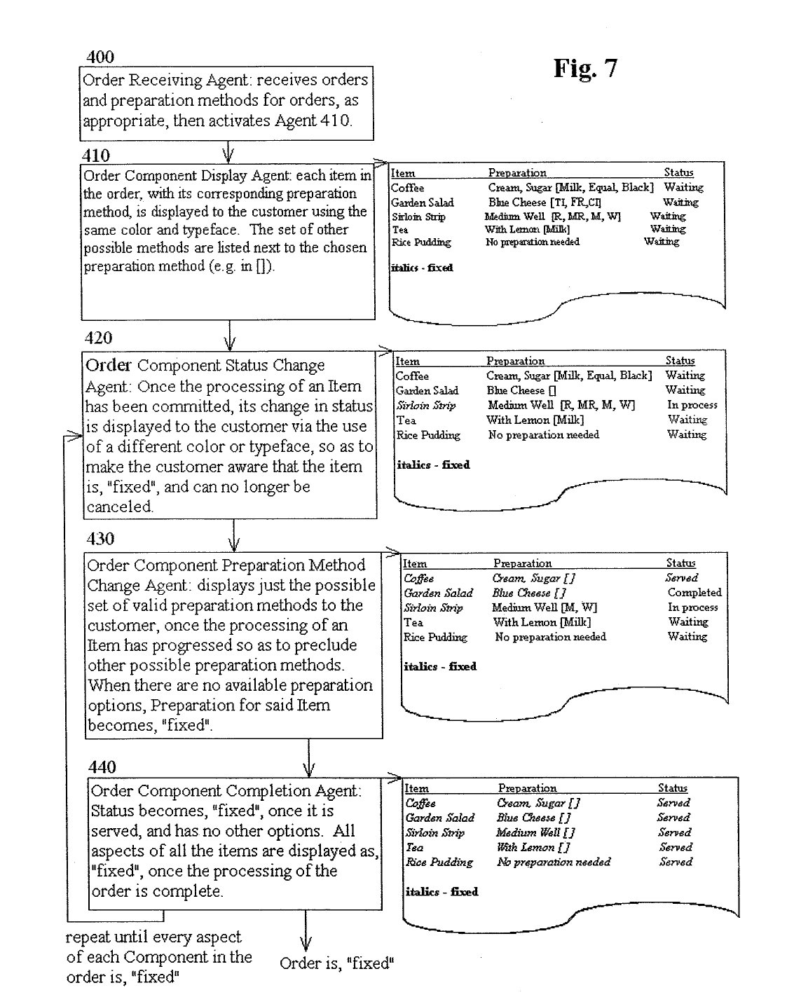

Thus, the invention provides a method for allowing the customer to cancel or change his or her order before such change will lead to a waste of resources. Referring to FIG. 7, the order is relayed to order Component Display Agent 410 by Order Receiving Agent 400. Order Component Display Agent 410 causes the components of the order of Customer 102 to be displayed along with components of the order that can be varied. Agent 430 displays only the possible set of valid changes available. The display is any conventional display at the area where Customer 102 receives or consumes his order, or where customer waits while his order is processed. The display can be a dedicated. Similarly, the display can be part of Device 101. The display can be an LCD display, a CRT, or any other display that can display the information served or communicated by order component display agent 410. For example, the display can be at the restaurant table assigned to Customer 102 at the establishment.

For example, if the customer ordered a sirloin strip medium cooked, the display might list the sirloin strip, and show other possible preparation methods available to the customer. When the sirloin strip is first placed on the grill, the whole range of methods, from rare to well done, appears in the list. Once a given amount of time has passed, for example, the customer can no longer change the order to cook the sirloin strip rare. This is because the steak is already cooked more than the rare and to provide a sirloin strip rare could only be accomplished by wasting the first steak.

Order Component Display Agent 410 activates order component status change agent 420. Order Component Status Change Agent 420 receives notification from Order Component Completion Agent 440 once the order for the component of the order has been committed. Order Component Status Change Agent 420 causes the change in the status of the order to be displayed on the display to indicate that the order for the component can no longer be canceled. This would mean that the steak is on the grill, for example. The committed status of the component can be indicated by changing the font type, font color, etc. that the component is displayed in. The display will preferably also show the status of the good (e.g., delivered, in process, etc.).

### Order Delivery

As described above, in various embodiments of the invention, the order will be delivered to the customer. For example, the establishment might be a pizza delivery business, and the availability of the delivery person might be the limiting resource. Thus, the invention provides a method for fulfilling the order comprising (a) receiving the location of at least one delivery person; (b) predicting when at least one delivery person will arrive at the establishment based on the locations of one or more drivers, (c) assigning the order to the delivery person, and (d) scheduling completion of the preparation of the order to coincide with the arrival of the delivery person at the establishment. A goal is to have the order prepared so that it is fresh and hot when the delivery person assigned to the order can take it when it is ready to go.

The steps can be performed through the same process as in FIG. 4, with the Trigger System Agent 205 used to determine when the delivery person is a predetermined distance from the establishment, and Order Matching Agent 220 associating delivery person with orders. Often, the delivery person is the limiting resource.

Where delivery drivers are the limiting resource, delivery team efficiency can be enhanced in various way. First, would be the implementation of a virtual delivery team. In a virtual delivery team, the team covers a large geographical area, which would encompass multiple restaurant locations. In this scenario, the multiple locations and the delivery team would be optimized as a group, such that one location and one subset of drivers are not overburdened with orders while another location and another subset of drivers are relatively idle. Alternately, a hybrid delivery team may be used. In a hybrid delivery team, a restaurant is able to maintain a lower driver staffing levels and use supplemental drivers, such as a taxi company, when demand is at peak levels.

Order assignment information preferably is communicated to the drivers. Using Notification Agent 500, Notification Database 505, and Notification Executor 510, discussed above, drivers are notified of order assignments, order un-assignments, re-assignments, and order instructions. Even though the driver's device 101 may display a list of instruction, however, the driver may be taught to only act on the first instruction since the other instruction may change as circumstances change. For example, a driver may receive an instruction such as, “Pick-up Order #23456, Pizza Joe's” or, “Deliver #23455, 111 N. Main St”. An un-assignment may be communicated by either removing an item from the instruction list, or by replacing one instruction with another instruction. Such an un-assignment could occur, for example, if the order was cancelled, or if the optimization system found it more optimal to have a different driver perform the delivery or task.

The location of the delivery person can be determined by a global positioning system, a satellite-based radio positioning system that can provide position, velocity and time information to users equipped with tracking devices and receivers, cellular tower triangulation or other ways known to the skilled artisan. The delivery person carries, wears, or uses (e.g., in his car), a device capable of communicating the location of the device (and hence of the delivery person) to Location Tracking Agent 295. This Ubiquitous Agent 280 makes available the location of any device its tracking to any agent described in FIGS. 3, 4a, 4b and 5. Order Matching Agent 220 associates orders with delivery persons based on establishment or service provider criteria. The device may also have features that enhance driver security, such as panic features, vehicle disablement features or other features that can alert proper authorities and the driver's employer in the event that a driver is the victim of a crime or involved in a traffic accident or other similarly unfortunate event.

In other various embodiments, not only the delivery person's location, but also information such as the number of drivers, their proximity to the pick-up location, and the number of deliveries each driver has yet to make, are used to predict when the delivery person will return back to the establishment. In these embodiments, the delivery person can have RF ID tag on his body or clothing, and an RF ID receiver in his delivery vehicle. When the delivery person's RF tag is no longer being read by the RF ID receiver, this information is communicated to Location Tracking Agent 295. Preferably, either the delivery person or his vehicle is also equipped with a GPS receiver and a transmitter of location information that is in communication with Location Tracking Agent 295. If the delivery person's RF ID tag is not being read by the RF ID receiver, and this occurs at a location consistent with a delivery location assigned to the delivery person, Trigger System Agent 205 assumes that the delivery person is delivering an order.

Alternately, the delivery person and delivery vehicle both have a GPS receiver and a transmitter of location information. The transmitter is in communication (or capable of communication) with Trigger System Agent 205. Current GPS technology is accurate within about five feet. Thus, if the delivery person's GPS receiver and transmitter is more than five feet from the delivery vehicle's receiver and transmitter, Trigger System Agent 205 assumes that the delivery person is delivering an order if this occurs at a location consistent with a delivery location of an order.

Thus, Trigger System Agent 205 can access information about both the location of the delivery person but also information indicative of which orders he has delivered. This information is preferably communicated to Order Matching Agent 220 either directly or through other agents.

The delivery person does not need to be physically at the establishment when the assignment is made. The establishment or service provider will assign the delivery person to a particular order based on any of a number of factors, such as the predicted ability of the delivery person to deliver the order within the time requested by the customer, whether the delivery person has been assigned to other orders that need to be delivered within a predefined proximity to the delivery address of the order, whether the delivery person has been assigned to other orders that need to be delivered at about the same time as the order, and so forth. Once an order is assigned to a delivery person, the delivery person is preferably notified of the assignment by Notification Executor 510.

In some cases, orders for delivery may be placed with special delivery instructions. For example, there may be instructions to bring the order to a particular door of a particular house. Thus, in this embodiment, the delivery person assigned to the order is notified of these instructions when he is within a predetermined distance from the delivery location of the order by Notification Executor 510.

It will be apparent to those skilled in the art that various modifications and variations can be made in the system and processes of the present invention without departing from the spirit or scope of the invention. Besides being a fast food restaurant, the service provider may be, for example, any merchant or service provider who can accept orders and satisfy the order upon the customer's arrival at a particular location.

While specific embodiments have been illustrated and described, numerous modifications come to mind without significantly departing from the spirit of the invention and the scope of protection is limited by the scope of the accompanying claims.

1-225. (canceled)

226. A computer-implemented method, in a computer system comprising one or more processors, of tracking a progress of a food order in a restaurant establishment, the method comprising:
receiving, in the computer system, the food order;
associating the food order with at least one item in the restaurant establishment, wherein the at least one item has an identifier physically associated with the at least one item; and
using the identifier to track a location of the at least one item in the restaurant establishment during fulfillment of the food order.

227. The computer-implemented method of claim 226, wherein the identifier comprises an electrically readable element.

228. The computer-implemented method of claim 227, wherein the electrically readable element comprises one of a radio frequency identification (RF ID) tag and a wireless transmitter.

229. The computer-implemented method of claim 226, wherein the identifier comprises an optically readable marker.

230. The computer-implemented method of claim 229, wherein the optically readable marker comprises a bar code.

231. The computer-implemented method of claim 226, wherein associating the food order with the at least one item in the restaurant establishment comprises associating the food order with the at least one item in the computer system.

232. The computer-implemented method of claim 226, wherein associating the food order with the at least one item comprises associating the food order with a first item comprising a food item and associating the food order with a second item comprising a piece of kitchenware.

233. The computer-implemented method of claim 232, wherein, prior to associating the food order with the first item comprising the food item and the second item comprising the piece of kitchenware, the food item is associated with the piece of kitchenware.

234. The computer-implemented method of claim 226, farther comprising placing a plurality of detectors configured to detect the identifier at a plurality of locations in the restaurant establishment; and
determining the location of the at least one item in the restaurant establishment during fulfillment of the food order using at least one of the plurality of detectors.

235. The computer-implemented method of claim 226, further comprising determining availability of the at least one item.

236. The computer-implemented method of claim 226, wherein the at least one item comprises at least one food item and using the identifier to track the location of the at least one item in the restaurant establishment during fulfillment of the food order comprises tracking a progress of preparation of the at least one food item.

237 The computer-implemented method of claim 226, wherein the at least one item comprises at least one food item and associating the food order with the at least one item in the restaurant establishment comprises associating the food order with the at least one food item when the identifier of the food item is detected by a detector associated with a location provided for consumption of the food order.

238. The computer-implemented method of claim 237, further comprising electronically charging a customer for the food order after the food order is associated with the at least one food item.

239. A computer-implemented method, in a computer system comprising one or more processors, of tracking a progress of a food order in a restaurant establishment, the method comprising:
receiving, in the computer system, the food order for at least one food item;
associating at least one piece of kitchenware with the at least one food item, wherein the at least one piece of kitchenware has an identifier physically associated with the at least one piece of kitchenware; and
tracking the at least one food item by tracking a location of the at least one piece of kitchenware in the restaurant establishment using the identifier.

240. The computer-implemented method of claim 239, wherein the identifier comprises an electrically readable element.

241. The computer-implemented method of claim 240, wherein the electrically readable element comprises one of a radio frequency identification (RF ID) tag and a wireless transmitter.

242. The computer-implemented method of claim 239, wherein the identifier comprises an optically readable marker.

243. The computer-implemented method of claim 239, wherein tracking the at least one food item comprises tracking a progress of preparation of the at least one food item.

244. The computer-implemented method of claim 239, further comprising determining availability of the at least food item.

245. The computer-implemented method of claim 239, further comprising
determining whether the at least one piece of kitchenware is at a location provided for consumption of the food order; and
electronically charging a customer for the food order after it is determined that the at least one piece of kitchenware is at the location provided for consumption of the food order.

246. The computer-implemented method of claim 239, wherein associating the at least one piece of kitchenware with the at least one food item comprises associating the at least one piece of kitchenware with the at least one food item in the computer system.
